(19) United States
(12) Patent Application Publication
(10) Pub. No.: US 2013/0249305 A1
(43) Pub. Date: Sep. 26, 2013

(54) POWER TRANSMISSION APPARATUS, POWER RECEPTION APPARATUS, AND POWER TRANSMISSION METHOD

(71) Applicant: KABUSHIKI KAISHA TOSHIBA, Tokyo (JP)

(72) Inventors: Hiroki KUDO, Kawasaki-Shi (JP); Noritaka DEGUCHI, Yokohama-Shi (JP); Hiroki SHOKI, Yokohama-Shi (JP); Noriaki OODACHI, Kawasaki-Shi (JP); Kenichirou OGAWA, Tokyo (JP)

(73) Assignee: KABUSHIKI KAISHA TOSHIBA, Tokyo (JP)

(21) Appl. No.: 13/739,552

(22) Filed: Jan. 11, 2013

(30) Foreign Application Priority Data
Mar. 21, 2012 (JP) 2012-064107

(51) Int. Cl. H02J 17/00; H02J 7/00

(52) U.S. Cl. CPC H02J 17/00; H02J 7/00
USPC 307/104; 320/108

(57) ABSTRACT

There is provided a power transmission apparatus which transmits power generated by a power source to one or more power reception apparatuses. The power transmission apparatus includes a power allocation processing unit and a power transmission unit. The power allocation processing unit allocates first resources which are parts of resources for transmitting the power to the power reception apparatuses, based on requested power of the power reception apparatuses, and allocates second resources which are resources with the exception of first resources to a power reception apparatus selected from the power reception apparatuses based on power transmission characteristics of the power reception apparatuses. The power transmission unit transmits the power to the power reception apparatuses using first resources and second resources.

### CROSS REFERENCE TO RELATED APPLICATIONS

This application is based upon and claims the benefit of priority from the prior Japanese Patent Application No. 2012-64107 filed on Mar. 21, 2012, the entire contents of which are incorporated herein by reference.

### FIELD

Embodiments described herein relate to a power transmission apparatus, a power reception apparatus, and a power transmission method, and for example, relate to a technology of allocating resources for power transmission to a plurality of power reception apparatuses.

### BACKGROUND

A wireless power transmission performed via an electromagnetic coupling between a power transmission coil and a power reception coil has been employed for various apparatuses because of its convenience. In wireless power transmission, power is transferred via a space. When the power is transmitted to a plurality of power reception apparatuses, the transmission efficiency at the time of reception by the power reception apparatuses differ from each other. Therefore, it is difficult to supply necessary power to each of the power reception apparatuses. On the other hand, a method is known in which an allocation period (allocation chance) is determined based on the power required by the power reception apparatus and coupling efficiency (transmission efficiency) in a system for transmitting the power to a plurality of power reception apparatuses by time division. In the known example, a method of determining the allocation period based on a value calculated with necessary power/transmission efficiency has been employed.

In the conventional power transmission method, the transmission efficiency comes to the denominator in a calculation formula that determines the allocation period. Therefore, many allocation chances are given to a power reception apparatus with low transmission efficiency, and thus there is a problem of deteriorating the system efficiency. Also, even a power reception apparatus that requires large necessary power is preferentially given the allocation chances. Therefore, there is also a problem of causing inequality among the power reception apparatuses.

### BRIEF DESCRIPTION OF THE DRAWINGS

FIG. 1 is a diagram showing an example of a wireless power transmission system according to the present embodiment;

FIG. 2 is a diagram showing an example 1 of the power transmission apparatus of the wireless power transmission system according to the present embodiment;

FIG. 3 is a diagram showing an example 2 of the power transmission apparatus of the wireless power transmission system according to the present embodiment;

FIG. 4 is a diagram showing an example 3 of the power transmission apparatus of the wireless power transmission system according to the present embodiment;

FIG. 5 is a diagram showing an example 4 of the power transmission apparatus of the wireless power transmission system according to the present embodiment;

FIG. 6 is a diagram showing configuration examples 1 and 2 in a case of applying the example 4 of the power transmission apparatus of the wireless power transmission system according to the present embodiment;

FIG. 7 is a diagram showing a configuration example 3 in a case of the example 4 of the power transmission apparatus of the wireless power transmission system according to the present embodiment;

FIG. 8 is a diagram showing a first configuration example of a wireless power transmission apparatus according to the present embodiment;

FIG. 9 is a flowchart of a first operation example of the wireless power transmission apparatus according to the present embodiment;

FIG. 10 is a diagram showing a time division power frame configuration in the first operation example of the wireless power transmission apparatus according to the present embodiment;

FIG. 11 is a diagram showing a frequency division power allocation configuration in the first operation example of the wireless power transmission apparatus according to the present embodiment;

FIG. 12 is a diagram showing a space division power allocation configuration in the first operation example of the wireless power transmission apparatus according to the present embodiment;

FIG. 13 is a diagram showing a PF scheduling example in the first operation example of the wireless power transmission apparatus according to the present embodiment;

FIG. 14 is a diagram showing a second configuration example of the wireless power transmission apparatus according to the present embodiment;

FIG. 15 is a flowchart of a second operation example of the wireless power transmission apparatus according to the present embodiment;

FIG. 16 is a flowchart of a modification of the second operation example of the wireless power transmission apparatus according to the present embodiment;

FIG. 17 is a flowchart of a third operation example of the wireless power transmission apparatus according to the present embodiment;

FIG. 18 is a flowchart of a modification 1 of the third operation example of the wireless power transmission apparatus according to the present embodiment;

FIG. 19 is a flowchart of a modification 2 of the third operation example of the wireless power transmission apparatus according to the present embodiment;

FIG. 20 is a diagram showing an example of the wireless power transmission system including a power reception apparatus according to the present embodiment;

FIG. 21 is a diagram showing a first configuration example of a wireless transmission power reception apparatus according to the present embodiment;

FIG. 22 is a flowchart of a first operation example of the wireless transmission power reception apparatus according to the present embodiment; and

FIG. 23 is a diagram showing first to third power information of the first operation example of the wireless transmission power reception apparatus according to the present embodiment.

### DETAILED DESCRIPTION

According to some embodiments, there is provided a power transmission apparatus which transmits power generated by a power source to one or more power reception apparatuses.

The power transmission apparatus includes a power allocation processing unit and a power transmission unit.

The power allocation processing unit allocates first resources which are parts of resources for transmitting the power to the power reception apparatuses, based on requested power of the power reception apparatuses, and allocates second resources which are resources with the exception of first resources to a power reception apparatus selected from the power reception apparatuses based on power transmission characteristics of the power reception apparatuses.

The power transmission unit transmits the power to the power reception apparatuses using first resources and second resources.

The present embodiments will be hereafter described in detail with reference to the drawings.

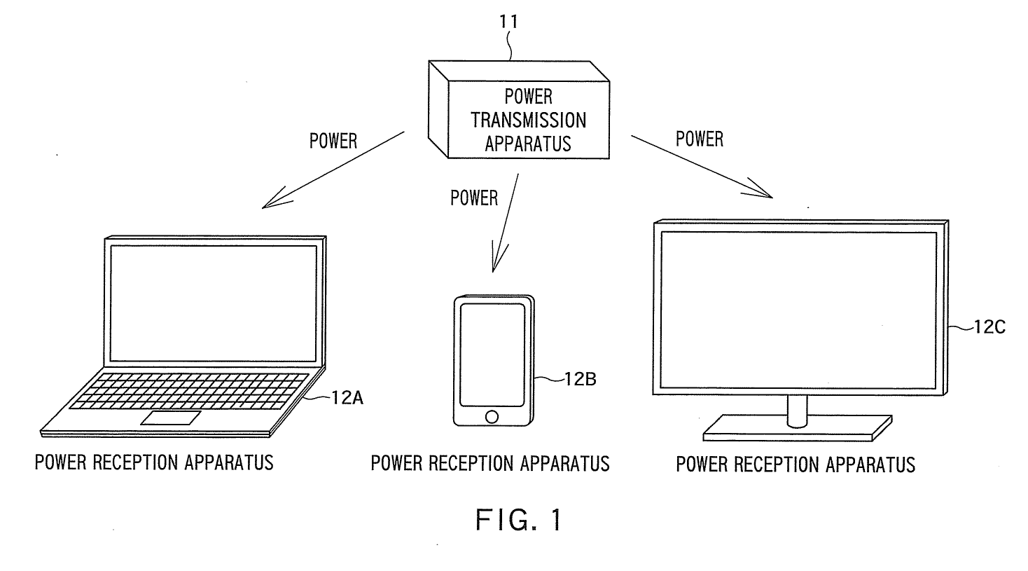

FIG. 1 shows an example of a wireless power transmission system according to the present embodiment. The present embodiment relates to a system that wirelessly supplies power to one or more of power reception apparatuses 12A, 12B, and 12C from a power transmission apparatus (wireless power transmission apparatus) 11.

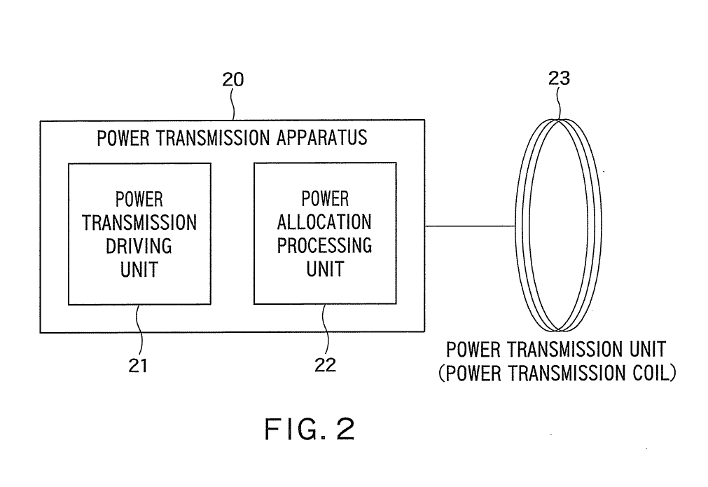

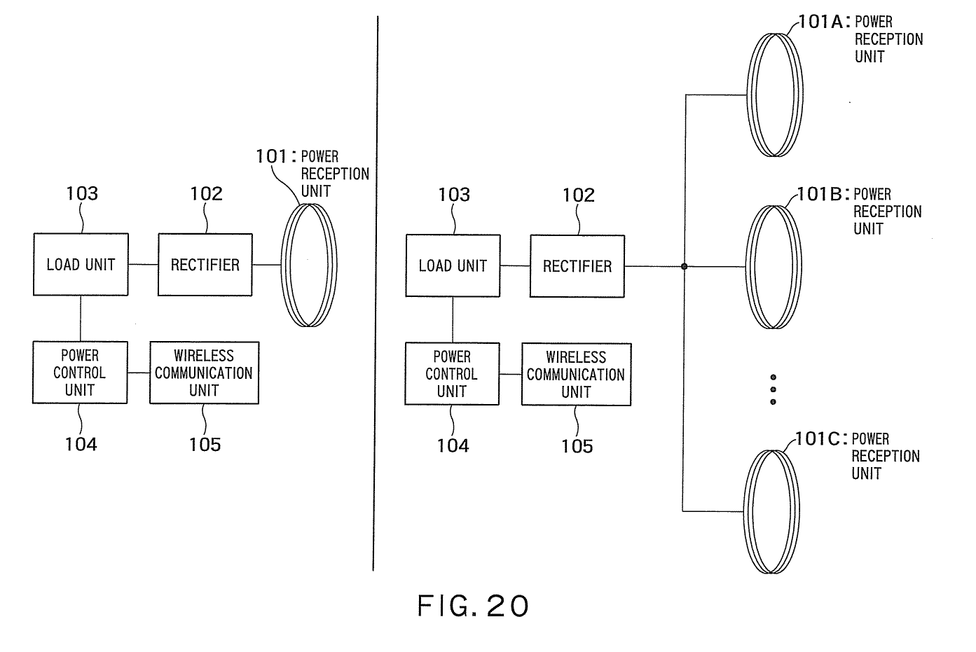

FIG. 2 shows an example of a power transmission apparatus of the wireless power transmission system according to the present embodiment. A power transmission apparatus 20 of the present embodiment includes at least one power transmission unit 23. At a power reception side, there is one or more power reception apparatuses that include at least one power reception unit (see FIG. 20 described below). The power transmission unit 23 uses a self-resonant coil, or a coil and a capacitor and an inductor connected therewith to resonate. The self-resonant coil can employ any shape.

The power transmission apparatus includes a power transmission driving unit 21 that transmits a power signal having predetermined power, voltage, electricity, and frequency, and a power allocation processing unit 22 that performs calculation for power allocation and resource allocation to one or more of the above-described power reception apparatuses. In this configuration, a power source is provided outside the power transmission apparatus. Note that the power reception unit of the power reception apparatus also uses a self-resonant coil, or a coil and a capacitor and an inductor connected therewith to resonate. The self-resonant can employ any shape.

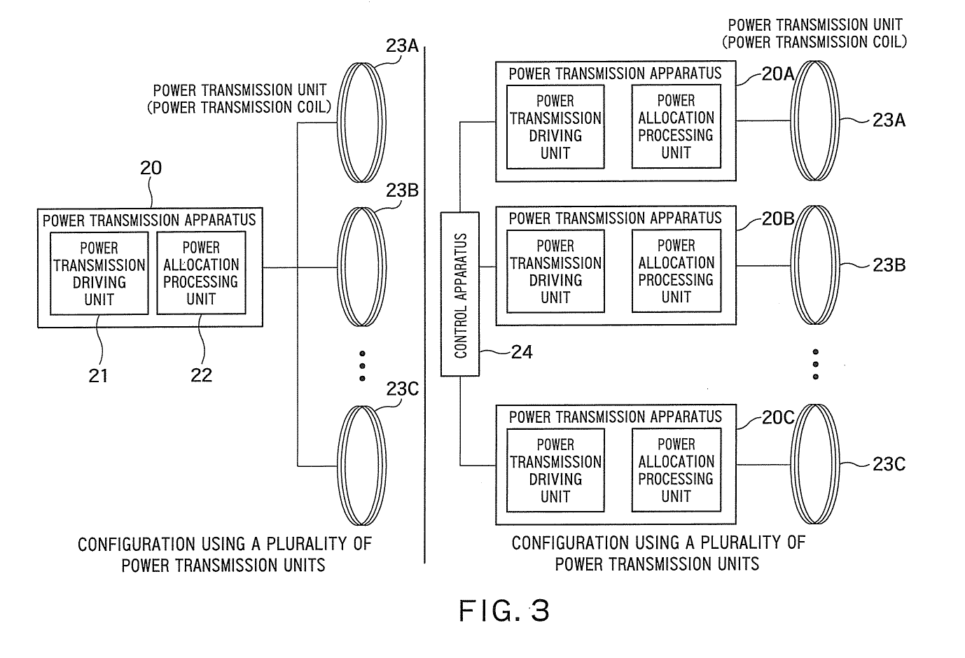

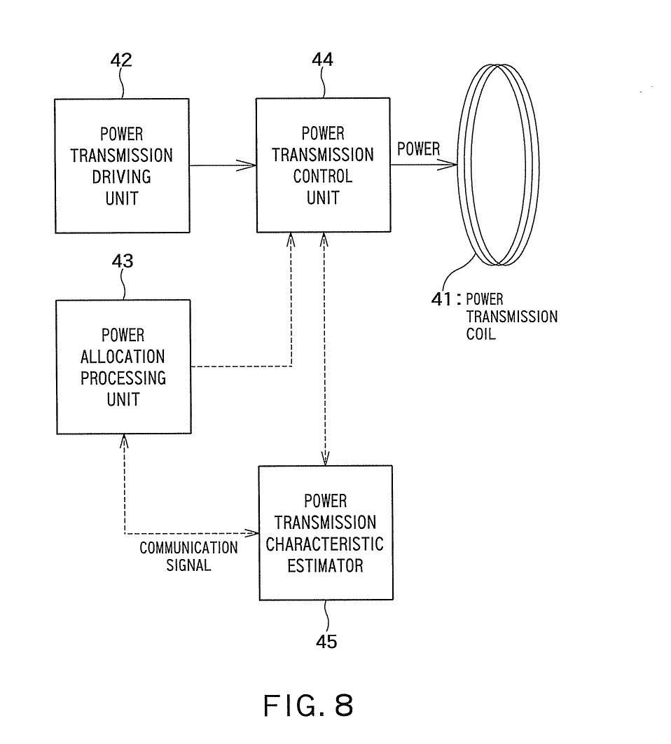

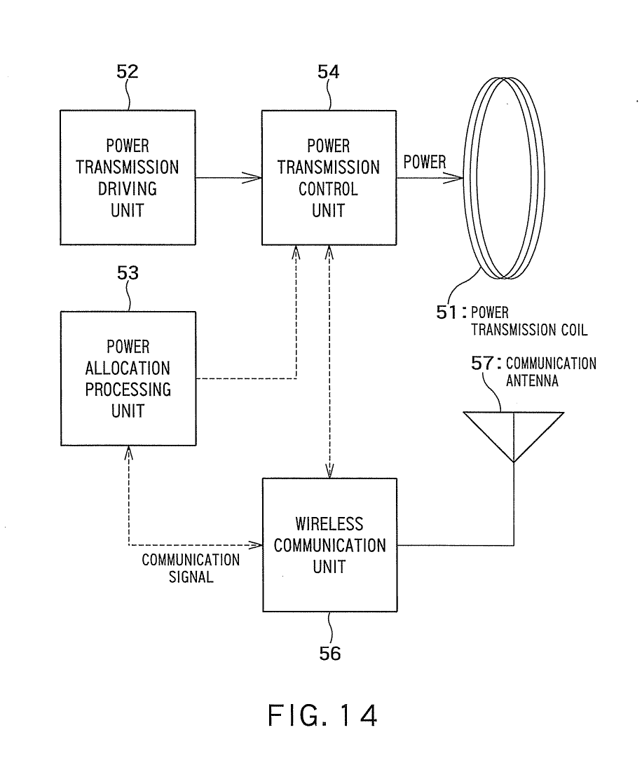

Although, in FIG. 2, an example configured from one power transmission apparatus, it is possible to perform the power transmission using a plurality of power transmission units 23A, 23B, and 23C as shown in the left of FIG. 3. Also, as shown in the right of FIG. 3, it is possible to perform the power transmission by a plurality of power transmission apparatuses 20A, 20B, and 20C respectively including the power transmission units 23A, 23B, and 23C. Also, a control apparatus 24 that controls each power transmission apparatus is disposed. In the case of the right of FIG. 3, a power allocation processing unit of each power transmission apparatus may be gathered to the control apparatus 24. Also, a power transmission characteristic estimator (see FIG. 8) and a wireless communication unit (see FIG. 14) described below may be gathered to the control apparatus 24.

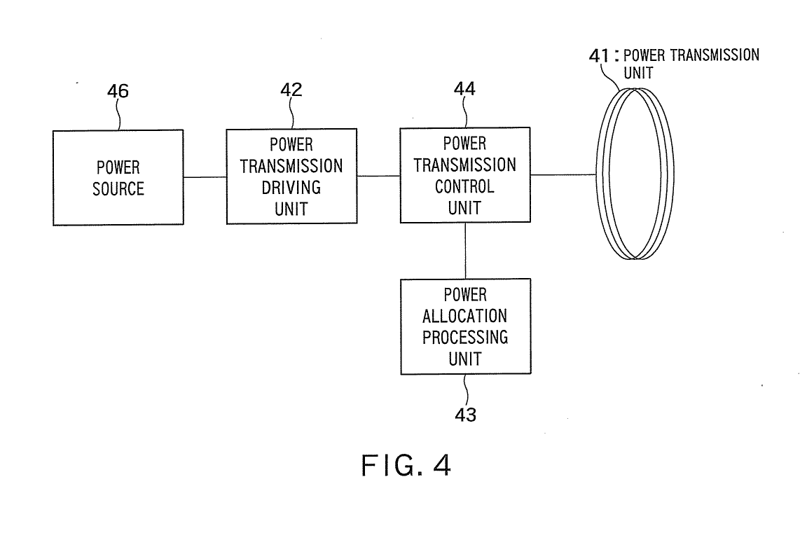

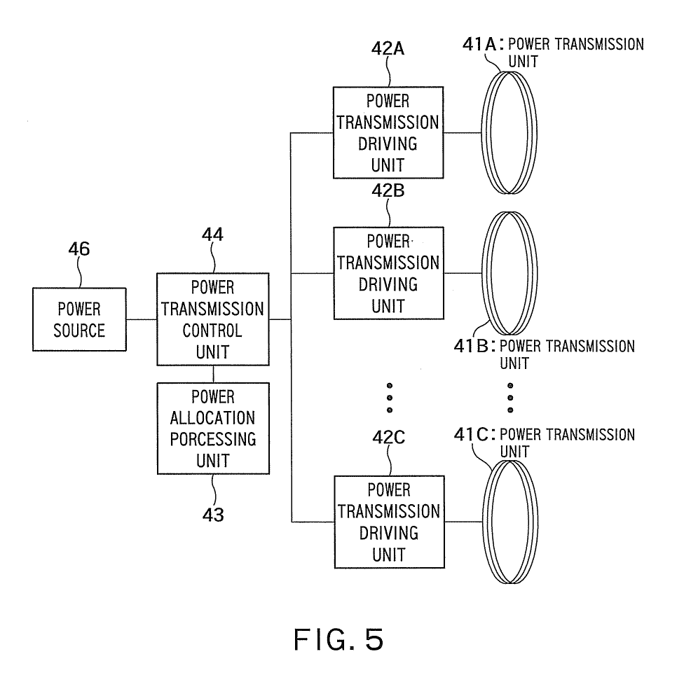

Also, the power transmission apparatus including a power source unit is shown in FIGS. 4 and 5. Referring to FIG. 4, AC or DC power supplied from a power source is input to a power transmission driving unit 42, and a power signal having a predetermined frequency, voltage, and electricity is output from the power transmission driving unit 42. The power signal output from the power transmission driving unit 42 is input to a power transmission control unit 44, and the signal is transmitted by the power transmission control unit 44 to one or more of power reception apparatuses via the power transmission unit 41. A power allocation processing unit 43 calculates an allocation resource for each power reception apparatus when power allocation to one or more of power reception apparatuses is performed, and notifies the power transmission control unit 44 of a calculation result. The power transmission control unit 44 controls the power transmission in accordance with the allocated resources calculated by the power allocation processing unit 43. The configuration like FIG. 4 is a configuration applied to a usage scene in which wireless power supply to a plurality of OA equipment or PCs on a desk is performed, for example.

Next, FIG. 5 shows a configuration in which the power allocation processing unit and the power transmission driving unit in the configuration of FIG. 4 are interchanged. In this case, a plurality of power transmission driving units 42A to 42C and a plurality of power transmission units 41A to 41C are respectively provided, and the power transmission control unit 43 allocates the DC or AC power supplied from a power source 46 to each of the power transmission driving units 42A to 42C based on the allocation resource calculated in the power allocation processing unit 43. The power transmission driving units 42A to 42C output a power signal having a predetermined frequency, voltage, and electricity to the power transmission units 41A to 41C in accordance with the DC or AC power input from the power transmission control unit 43.

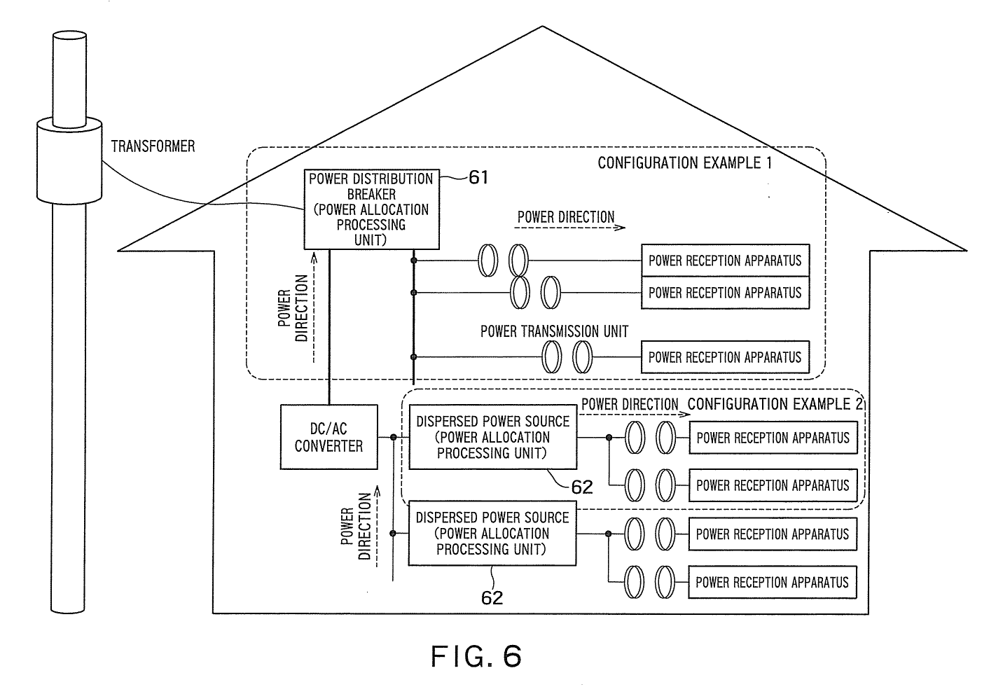

An example of specific application of the configuration of FIG. 5 is shown in FIG. 6. As shown in FIG. 6, when the wireless power transmission to a plurality of power reception apparatuses located in various places at home is performed, there could be a configuration in which a wiring breaker 61 as a breaker is provided with a power source and a power allocation processing unit, like the configuration example 1 in the drawing, or a configuration in which a dispersed power source unit 62 such as solar power generation or a battery is provided with a power source and a power allocation processing unit, and the power is transmitted to a power reception apparatus, like the configuration example 2. In these cases, the power can be managed by the transmission power from the wiring breaker 61 or the dispersed power source unit 62. For example, when a power allocation process is performed in the wiring breaker 61, the power allocation can be performed not to exceed an upper limit of contract power in a home, and when the power allocation process is performed in the dispersed power source unit 62, the power allocation can be performed according to a power generation amount or a charging capacity of each dispersed power source unit 62.

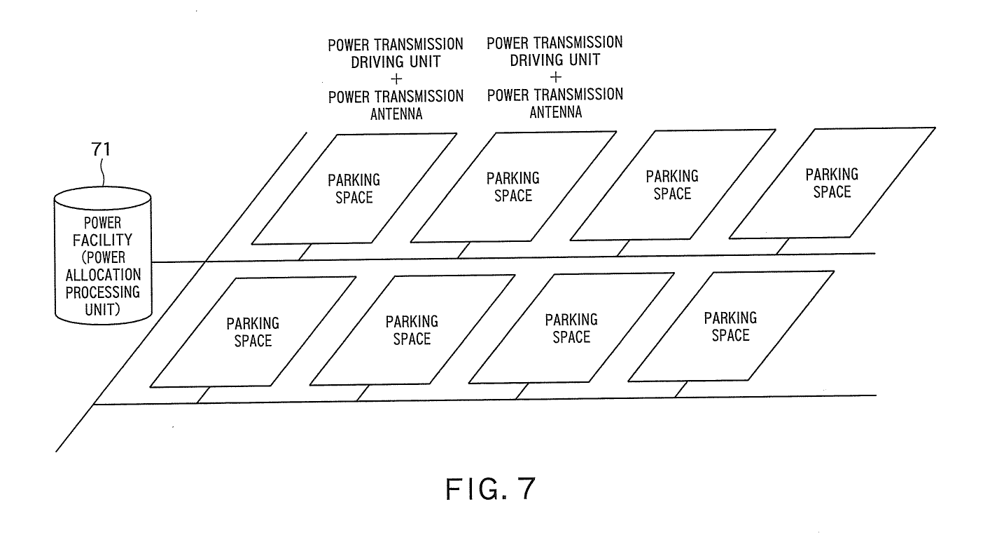

Also, the configuration example of FIG. 5 can be widely applied to a configuration other than the configuration examples 1 and 2 shown in FIG. 6. For example, as shown in FIG. 7, in a case of performing the wireless power transmission to an electric vehicle in a parking facility, this proposed method can be employed at the time of determining the allocation resource from suppliable power when the power is transmitted to a plurality of electric vehicles from the power facility 71.

FIG. 8 shows a first configuration example of the wireless power transmission apparatus (power transmission apparatus) in the present embodiment. The wireless power transmission apparatus is configured from the power transmission unit 41, the power transmission control unit 44, the power transmission driving unit 42, the power allocation processing unit 43, and a power transmission characteristic estimator 45. A power transmission coil 41 and the power transmission control unit 44 are equivalent to a power transmission unit that transmits the power to the power reception apparatus based on the allocation resource.

The power transmission unit 41 is a power transmission coil used as an antenna for power transmission. The power transmission driving unit 42 generates a power signal having a predetermined frequency, voltage, and electricity, and outputs it to the power transmission coil. The power allocation processing unit 43 calculates the resource allocation when the power allocation is performed to a plurality of the power reception apparatuses. The power transmission control unit 44 controls the power transmission in accordance with the allocation resource with respect to each power reception apparatus, which is determined by the power allocation processing unit 43. The power transmission characteristic estimator 45 estimates power transmission efficiency of each power reception apparatus.

Here, the allocation resource corresponds to an allocation period in a case of performing time division multiplexing, to a frequency and transmission power to be allocated to each frequency in a case of performing frequency division multiplexing, and to a space to be allocated in a case of performing space division multiplexing.

Also, as another method of transmitting power with same frequency by another method other than the time division multiplexing or space division multiplexing, a method of controlling load impedance of a power reception apparatus in accordance with necessary power is considered.

In the present embodiment, a method of calculating the power allocation applicable to any of these multiplexing methods is proposed.

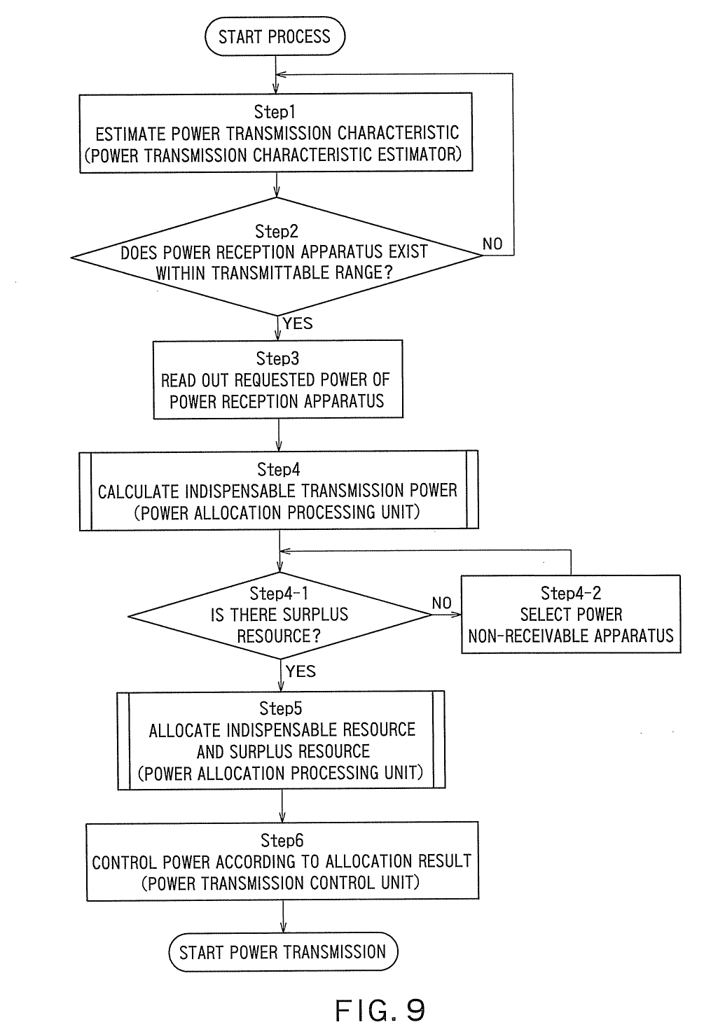

A first operation example of the wireless power transmission apparatus according to the present embodiment will be described with reference to FIGS. 9, 10, 11, 12, 13, and 14.

FIG. 9 shows a flowchart in the first operation example.

### (Step 1: Estimation of a Power Transmission Characteristic)

In the first operation example, first, as step 1, the power transmission efficiency is estimated by the power transmission characteristic estimator 45. A method of estimating the power transmission efficiency can perform estimation using a frequency characteristic of reflection when a power signal input to a power transmission coil is reflected due to inconsistency of the impedance, for example.

It is known that a wireless power transmission system called a “magnetic resonant type” system is expressed by an equivalent circuit that is almost the same as an inter-resonatorband pass filter (Reference Document 1: Ikuo Awai et al., “Comparative study of resonators for resonant-type wireless power transfer system”, IEICE WPT 2010-01). In this magnetic resonant type wireless power transmission system, when the transmission power and reception power apparatuses are coupled with each other, two minimum values are detected for the reflection frequency characteristic. These minimum values of this reflection characteristic appear in two resonance modes called a magnetic wall and an electric wall shown in the inter-resonator band pass filter (Reference Document 2: Yoshio Kobayashi et al., “Microwave dielectric filter”, edited by the institute of electronics, information and communication engineers, Mar. 30, 2007). In the inter-resonator band pass filter, the following formula is established between the two resonance modes and a coil coupling coefficient k.

$$k = \frac{{f}_{high}^{2} - {f}_{low}^{2}}{{f}_{high}^{2} + {f}_{low }^{2}}$$

Note that f_{low} and f_{high} respectively represent a lower minimum frequency and a higher minimum frequency between the two minimum frequencies. Therefore, the coupling coefficient can be estimated by measuring the two minimum frequencies from the reflection frequency characteristic and using the formula.

A theoretical transmission efficiency η can be calculated with the following formula using the coupling coefficient, a Q value (Q₁) that indicates the resonance strength of the power transmission coil of the power transmission apparatus and a Q value (Q₂) that indicates the resonance strength of the power transmission coil of the power reception apparatus.

$$η = \frac{2 + {k}^{2} {Q}_{1} {Q}_{2} - 2 \sqrt{1 + {k}^{2} {Q}_{1} {Q}_{2}}}{{k}^{2} {Q}_{1} {Q}_{2 }}$$

The power transmission characteristic estimator 45 in the present proposal may use a method other than the above-described method to estimate the transmission efficiency.

### (Step 2: Determination of Power Transmission/Non-Transmission of a Power Reception Apparatus)

Next, as step 2, it is determined whether the power reception apparatus exists within a transmittable range using the estimated transmission efficiency. When the transmission efficiency is considerably deteriorated, the power transmission is not performed. Therefore, it is possible to prevent considerable deterioration of the transmission efficiency as the whole system. As a method of determining whether the power reception apparatus exists in the transmittable range, it is possible to perform threshold-value determination of the transmission efficiency estimated in step 1. Defining that a threshold value to be determined is a transmission efficiency threshold value, it is possible to dynamically change the transmission efficiency threshold value according to the number of power reception apparatuses. For example, when there is a plurality of power reception apparatuses, the system transmission efficiency can be improved by setting the transmission efficiency threshold value to be a high value such as 80%. Also, when the number of power reception apparatuses is small such as one apparatus, it is also possible to perform the power transmission to the power reception apparatus having a deteriorated transmission efficiency by setting the transmission efficiency threshold value to be a low value such as 50%, whereby the power transmission in accordance with various power reception apparatuses becomes possible. The transmission efficiency threshold value is not limited to the above-described value, and can be set to other value.

### (Step 3: Reading Out of Requested Power of a Power Reception Apparatus)

In step 2, when the power reception apparatus does not exist in the transmittable range, the flow returns to step 1 again, while the flow moves into step 3 when the power reception apparatus exists in the transmittable range. In step 3, requested power information of the power reception apparatus stored in a memory in advance is read out. This requested power information is used at the time of calculating the allocation resource in next step 4. This requested power information corresponds to the power required by a battery when charging to the battery is performed, and corresponds to the power required by a load or consumed by the load when supplying of the power to the load is performed instead of charging to the battery, for example.

### (Step 4: Calculation of Indispensable Transmission Power/Calculation of a Surplus Allocation Resource)

Next, as step 4, indispensable transmission power of each power receiving apparatus and a surplus allocation resource are calculated by the power allocation processing unit 43. The following steps 4 to 6 are performed by the power allocation processing unit 43, and the allocation resource to each power receiving apparatus is determined through these procedures. For example, the allocation resource is determined by indispensable transmission power information P_{need} [k] with respect to each power reception apparatus k calculated with the following formula.

$${P}_{need} [ k ] = \frac{{P}_{req} [ k ]}{η [ k ]} \qquad ( 1 )$$

Here, P_{req} [k] and η [k] respectively represent the request power information and the transmission efficiency information in the power reception apparatus k. A result calculated with the above-described formula (1) indicates the transmission power necessary for supplying minimum necessary power to operate the power reception apparatus. Therefore, it is necessary for all of the power reception apparatuses to satisfy this indispensable transmission power information P_{need} [k], and is necessary to perform scheduling of allocation resources based on the information. It becomes possible to improve the system efficiency while providing each power reception apparatus with necessary power by devising an allocation method of the surplus allocation resource that is a difference between an upper limit of allocatable resources and all of indispensable allocation resources of each power receiving apparatus calculated from P_{need} [k].

Note that the above-described method of calculating the indispensable transmission power information P_{need} [k] is an example, and differs according to the multiplexing method. Hereafter, a method of calculating the indispensable transmission power information and a method of calculating the surplus allocation resource will be described according to a kind of the multiplexing method.

### (Calculation of a Surplus Allocation Resource by Time Division Multiplexing)

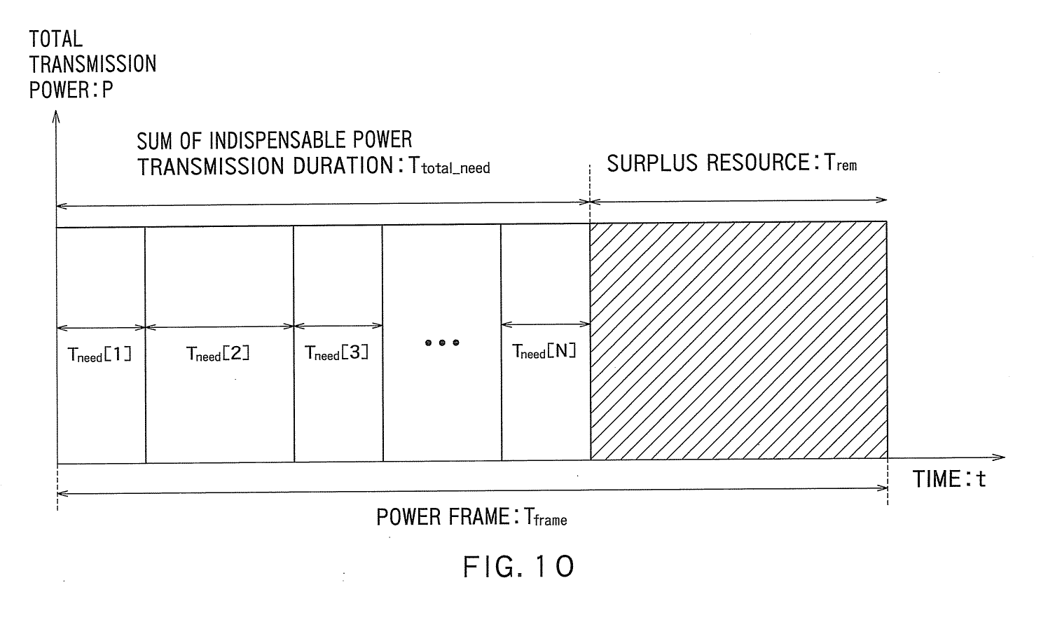

In a case of the time division multiplexing, the allocation resource is power transmission duration. For example, as shown in FIG. 10, assume that power transmission duration T_{need} [k] is allocated to the power reception apparatus k with one power frame length as T_{frame}. In this case, the indispensable power transmission duration T_{need} [k] with respect to the power reception apparatus k is calculated with the following formula using the indispensable transmission power information P_{need [k] and a power transmission power upper limit P}_{Tx}_{_{—}}ₘₐₓ calculated with the formula (1).

$${T}_{need} [ k ] = \frac{{P}_{need} [ k ] * {T}_{frame}}{{P}_{Tx \_ ma x}} \qquad ( 2 )$$

The indispensable power transmission duration T_{need} [k] is calculated using the formula (2) with respect to all of the power transmission apparatuses to which the power transmission is performed. This T_{need} [k] serves as the allocation resource with respect to each power reception apparatus. Also, a sum Tₜₒₜₐₗ_{_{—}}_{need} of the indispensable power transmission duration of the power reception apparatuses is calculated with the following formula where the total number of the power reception apparatuses is N.

$${T}_{total \_ need} = {\sum }_{k = 1}^{N} {T}_{need} [ k ] \qquad ( 3 )$$

Tₜₒₜₐₗ_{_{—}}_{need} calculated with the formula (3) is the indispensable power transmission duration necessary for stably operating all of the power reception apparatuses. A surplus allocation resource Tᵣₑₘ in the time division multiplexing is calculated by taking the difference between this Tₜₒₜₐₗ_{_{—}}_{need} and T_{frame}, which is the power frame length.

Tᵣₑₙₜ=T_{frame}−Tₜₒₜₐₗ_{_{—}}_{need} (4)

When the surplus allocation resource Tᵣₑₘ calculated with the formula (4) is negative (No at step 4-1), power transmission capability necessary for the number of power reception apparatuses N is insufficient. Therefore, any one or more of reception terminals to which the power transmission is not performed are selected from among the power transmission apparatuses (step 4-2) until Tᵣₑₘ becomes positive.

At this time, a method of selecting the power reception apparatus to which the power transmission is not performed can employ any method, and for example, in a case of power reception apparatuses including a battery, it is possible to select a power reception apparatus having a battery with a large remaining amount. Alternatively, it is possible to select the power reception apparatus using the estimated transmission efficiency η [k]. To improve the system efficiency, high system efficiency can be achieved by not performing the power transmission with respect to a power reception apparatus that has the smallest η [k] than other power reception apparatus. Also, a power reception apparatus to which the power transmission is performed and a power reception apparatus to which the power transmission is not performed can be classified using a priority defined by a user who uses the power reception apparatus. When Tᵣₑₘ is positive, the surplus allocation resource Tᵣₑₘ is used at the time of determining the allocation resource in step 5.

### (Calculation of a Surplus Allocation Resource in Frequency Division Multiplexing)

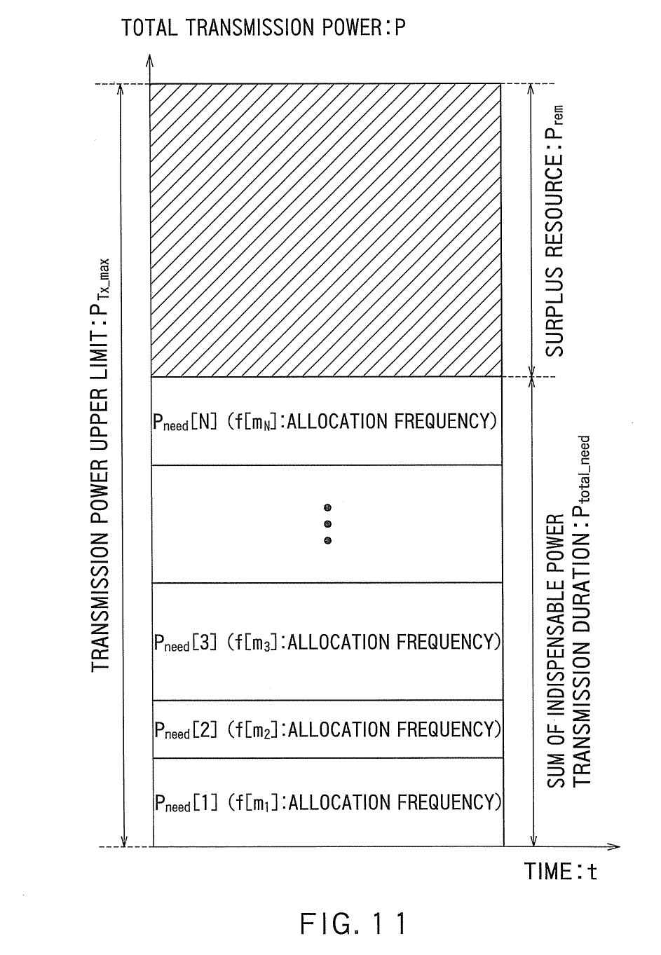

In a case of the frequency division multiplexing, as shown in FIG. 11, the allocation resource is a frequency and power to be allocated to each frequency. The frequency and the power to be allocated to each frequency are respectively defined as an allocation frequency and allocation power, and are described. The number of power reception apparatuses N is restricted to be equal to or less than N_{f} where an upper limit of the number of allocatable frequency divisions is N_{f}, and each allocation frequency is f [m] (1≦m≦N_{f}), and the allocation power of each frequency is P_{f} [m].

Here, a method of realizing the frequency division may use a plurality of power transmission coils having different resonant frequencies as shown in the right or left of FIG. 3.

Alternatively, the frequency division can be realized by changing a frequency matched with each power reception apparatus so that the matched frequency is different among each power reception apparatus. In this proposal, any method is applicable as long as the frequency division can be performed.

A) In a case of N_{f}≧N

When the number of power reception apparatuses N is equal to or less than N_{f}, the allocation frequencies of the number of power reception apparatuses are allocated to the power reception apparatuses among the allocation frequencies f [m]. It is necessary to estimate the transmission efficiency η [m] [k] in each allocation frequency of each power reception apparatus in step 1. It is desirable to determine the allocation frequency f [m] to be allocated to each power reception apparatus so as to maximize the system efficiency.

For example, first, (I) an allocation frequency that maximizes the transmission efficiency is selected in each power reception apparatus. Next, (II) the allocation frequency of the power reception apparatus k is compared with other allocation frequency, and if the allocation frequency does not accord with other allocation frequency, the power transmission is performed with the allocation frequency. If the allocation frequency accords with an allocation frequency of other power reception apparatus (for example, k′), the transmission efficiencies of the appropriate allocation frequency of the power reception apparatus k and the other power reception apparatus k′ are compared with each other, and the power reception apparatus having a higher transmission efficiency obtains the allocation chance of the appropriate allocation frequency. (III) The power reception apparatus that was not able to obtain the allocation chance selects an allocation frequency having second higher transmission efficiency after the appropriate allocation frequency, and confirms whether the selected allocation frequency does not accord with an allocation frequency of other power reception apparatus again. By repeating the procedures of (II) [symbol] (III), it becomes possible to determine the allocation frequency in each power reception apparatus, which maximizes the system efficiency. Also, a method other than the above-described method is applicable.

When all of the allocation frequencies are determined with respect to the power reception apparatuses, the indispensable transmission power P_{need} [k] with respect to the power reception apparatus k is calculated with the following formula. At this time, the following formula is established:

$${P}_{need} [ k ] = \frac{{P}_{req} [ k ]}{η [ f [ {m}^{′} ] ] [ k ]} \qquad ( 5 )$$

where the allocation frequency is f [m′]. Where a sum of all of the power reception apparatuses of the formula (5) is Pₜₒₜₐₗ_{_{—}}_{need}, Pₜₒₜₐₗ_{_{—}}_{need} is the indispensable transmission power for supplying necessary power to all of the power reception apparatuses.

$${P}_{total \_ need} = {\sum }_{k = 1}^{N} {P}_{need} [ k ] \qquad ( 6 )$$

The surplus allocation resource Pᵣₑₘ in the frequency division multiplexing is calculated by taking a difference between Pₜₒₜₐₗ_{_{—}}_{need} and P_{Tx}_{_{—}}ₘₐₓ which is an upper limit of the transmission power (maximum transmission power).

Pᵣₑₘ=P_{Tx}_{_{—}}ₘₐₓ−Pₜₒₜₐₗ_{_{—}}_{need} (7)

When the surplus allocation resource Pᵣₑₘ calculated with the above formula is negative (No at step 4-1), the power transmission capability necessary for the number of power reception apparatuses N becomes insufficient. Therefore, until Pᵣₑₘ becomes positive, one or more of power reception apparatuses to which the power transmission is not performed are selected from among the power reception apparatuses (step 4-2). Similar to the case of the time division multiplexing, any method may be employed for the method of selecting the power reception apparatus to which the power transmission is not performed. For example, it is favorable to select the power reception apparatus so as to maximize the system efficiency. When Pᵣₑₘ is positive, the surplus allocation resource Pᵣₑₘ is used at the time of determining the allocation resource in step 5.

B) IN a case of Nf<N

When the number of power reception apparatuses is larger than N_{f}, the allocation frequencies of the number of allocation frequencies f [m] are allocated to the power reception apparatuses. It is favorable to employ a method of selecting the power reception apparatuses to be allocated, which maximizes the system transmission efficiency. However, in a case of power reception apparatuses having a battery, the reception apparatus may be selected according to a remaining amount of the battery, or may be selected using the priority defined by a user who uses the power reception apparatus.

As a method of selecting the allocation frequency or a method of determining the allocation power with respect to each power reception apparatus, a method similar to the method described in the case of N_{f}≧N is applicable. At this time, a method similar to the above-described method is applicable to the indispensable transmission power P_{need} [k], the sum Pₜₒₜₐₗ_{_{—}}_{need} of the indispensable transmission power, and the surplus allocation resource Pᵣₑₘ.

Note that, in realizing the frequency division multiplexing, the system efficiency can be improved by dynamically changing the allocation frequency in accordance with the transmission efficiency of the power reception apparatus or time fluctuation of the requested power.

### (Calculation of a Surplus Allocation Resource in Space Division Multiplexing)

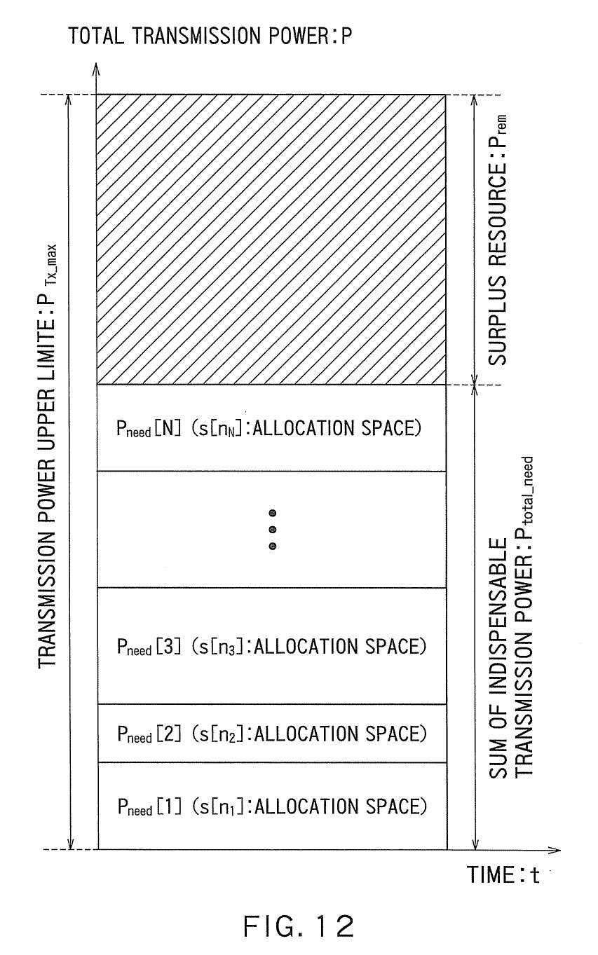

In a case of the space division multiplexing, as shown in FIG. 12, the allocation resource is a space (direction) and power to be allocated to each space, and these will be described by respectively defining as an allocation space and allocation power. First, the number of power reception apparatuses N is restricted to be equal to or less than Ns where an upper limit of the number of allocatable space divisions is Nₛ, each allocation space is s [n] (1≦n≦Nₛ), and the allocation power in each allocation space is Pₛ [n].

Here, as a method of dividing the space, for example, when assuming the magnetic resonant type wireless power transmission, there is a method of controlling the direction of a magnetic flux in the space by arraying the power transmission coil of the power transmission apparatus as shown in the right or left of FIG. 3. At that time, because the transmission efficiency is changed depending on the direction of the controlled magnetic flux, it is possible to realize the space division according to the direction of the magnetic flux.

For example, when the space division is realized using a power transmission coil array in the power transmission apparatus, it is necessary to estimate the direction of the power transmission coil of each power reception apparatus in order to estimate the transmission efficiency. As a method thereof, a coil of the power transmission coil array in the power transmission apparatus is used one by one and a coupling coefficient with each power transmission coil of the power reception apparatus is calculated with the above-described method, and the coupling coefficients between each power transmission coil in the power transmission apparatus and each power transmission coil in the power reception apparatus are estimated, whereby the direction of each power transmission coil in the power reception apparatus can be estimated. Because the direction of the magnetic flux controllable by the power transmission coil array in the power transmission apparatus depends on the number of power transmission coils, Nₛ is equal to the number of the power transmission coils of the power transmission apparatus. It is also possible to realize the space division multiplexing with a method other than the method with the coil array. The direction of the coil may be controlled.

A) In a case of Nₛ≧N

When the number of power reception apparatuses is equal to or less than Nₛ, the allocation spaces of the number of power reception apparatuses are allocated to the power reception apparatuses among the allocation spaces s[n]. It is necessary to estimate the transmission efficiency η [n] [k] in each allocation space of each power reception apparatus in step 1. It is desirable to determine the allocation space s [n] to be allocated to each power reception apparatus so as to maximize the system efficiency.

For example, first, (I) an allocation space that maximizes the transmission efficiency in each power reception apparatus is selected. Next, (II) the selected allocation space of the power reception apparatus k is compared with other allocation space, and if the selected allocation space does not accord with other allocation space, the power transmission is performed in the selected allocation space. If the selected allocation space accords with an allocation space of other power reception apparatus (for example, k′), the transmission efficiency in the appropriate allocation space of the power reception apparatus k and the other power reception apparatus k′, and the power reception apparatus having a higher transmission efficiency can obtain the allocation chance in the appropriate allocation space. (III) The power reception apparatus that was not able to obtain the allocation chance selects an allocation space having the second highest transmission efficiency, and confirms whether the selected allocation space does not accord with an allocation space of other power reception apparatus again. By repeating these procedures of (II) [symbol] (III), it becomes possible to determine the allocation space that maximizes the system efficiency in each power reception apparatus. Also, a method other than the above-described method is applicable.

When all of the allocation spaces with respect to the power reception apparatuses are determined, the indispensable transmission power P_{need} [k] with respect to the power reception apparatus k is calculated with the following formula. At this time, the following formula is established:

$${P}_{need} [ k ] = \frac{{P}_{req} [ k ]}{η [ s [ {n}^{′} ] ] [ k ]} \qquad ( 8 )$$

where the allocation space is s [n′]. Pₜₒₜₐₗ_{_{—}}_{need} is the indispensable transmission power for supplying the necessary power to all of the power reception apparatuses where the sum of the indispensable transmission power of the power reception apparatuses of the above formula is Pₜₒₜₐₗ_{_{—}}_{need}.

$${P}_{total \_ need} = {\sum }_{k = 1}^{N} {P}_{need} [ k ] \qquad ( 9 )$$

The surplus allocation resource Pᵣₑₘ in the space division multiplexing is calculated by taking a difference between this Pₜₒₜₐₗ_{_{—}}_{need} and P_{Tx}_{_{—}}ₘₐₓ, which is an upper limit of the transmission power (maximum transmission power).

Pᵣₑₘ=P_{Tx}_{_{—}}ₘₐₓ−Pₜₒₜₐₗ_{_{—}}_{need} (10)

When the surplus allocation resource Pᵣₑₘ calculated with the above formula is negative (No at step 4-1), the power transmission capability necessary for the number of power reception apparatuses N becomes insufficient. Therefore, until Pᵣₑₘ becomes positive, one or more of power reception apparatuses to which the power transmission is not performed are selected from among the power reception apparatuses (step 4-2). Similar to the time division multiplexing or the frequency division multiplexing, any method of selecting the power reception apparatus to which the power transmission is not performed may be employed. For example, it is favorable to select the power reception apparatus so as to maximize the system efficiency. When Pᵣₑₘ is positive, the surplus allocation resource is used at the determining processing of the allocation resource in step 5.

B) In a case of Ns<N

When the number of power reception apparatuses is larger than Nₛ, the allocation spaces of the number of allocation spaces s [n] are allocated to the power reception apparatuses. Although it is favorable to select a method of selecting the power reception apparatuses to be allocated so as to maximize the system transmission efficiency, the power reception apparatuses may be selected according to a remaining amount of the battery in a case of the power reception apparatuses having the battery. Alternatively, the power reception apparatuses may be selected using the priority defined by a user who uses the power reception apparatus.

A method similar to the method described in the case of Nₛ≧N is applicable to a method of determining the allocation space or a method of determining the allocation power with respect to each power reception apparatus. A similar method to the above-described formula is applicable to the indispensable transmission power P_{need} [k], the sum Pₜₒₜₐₗ_{_{—}}_{need} of the indispensable transmission power, and the surplus allocation resource Pᵣₑₘ.

Note that, in realizing the space division multiplexing, it is possible to improve the system efficiency by dynamically changing the allocation space in accordance with the transmission efficiency of the power reception apparatus or the time fluctuation of the requested power.

### (Step 5: Scheduling of an Allocation Resource)

In step 4, the indispensable allocation resource (the indispensable power transmission duration Tₜₒₜₐₗ_{_{—}}_{need} in the case of the time division multiplexing, the frequency and the indispensable transmission power Pₜₒₜₐₗ_{_{—}}_{need} in the case of the frequency division multiplexing, and the space and the indispensable transmission power Pₜₒₜₐₗ_{_{—}}_{need} in the case of the space division multiplexing), and the surplus allocation resource (Tᵣₑₘ in the case of the time division multiplexing, the remaining frequency and Pᵣₑₘ in the case of the frequency division multiplexing, and the remaining space and Pᵣₑₘ in the case of the space division multiplexing) have been calculated.

In step 5, power scheduling of allocation resources to each power reception apparatus is executed using the results. Hereafter, irrespective of multiplexing method, the indispensable allocation resource with respect to the power reception apparatus k is described as R_{need} [k], a total indispensable allocation resource with respect to all of the power reception apparatuses is described as Rₜₒₜₐₗ_{_{—}}_{need}, and the surplus allocation resource is described as Rᵣₑₘ.

First, it becomes possible to supply the requested power to all of the power reception apparatuses that are to receive the power by always allocating the indispensable allocation resource R_{need} [k] in each power reception apparatus. In this proposal, it is a characteristic of the method in which the surplus allocation resource Rᵣₑₘ is allocated to each power receiving apparatus so as to improve the system efficiency while the indispensable allocation resource is allocated. This surplus allocation resource Rᵣₑₘ is the power transmission capability that serves as remaining energy for supplying the power required by the power reception apparatuses. The improvement of the system efficiency cannot be obtained even if the surplus allocation resource Rᵣₑₘ is equally distributed to each power reception apparatus. However, in a case of performing the allocation based on the requested power/transmission efficiency, which is the formula used at the time of calculating the indispensable allocation resource, it means that the allocation is preferentially performed to the power reception apparatus having deteriorated transmission efficiency. Therefore, the system transmission efficiency becomes deteriorated. Therefore, in a case of the surplus allocation resource, the scheduling of the surplus allocation resource is performed based on different evaluation criteria from the method of calculating the indispensable allocation resource. Hereafter, a detail will be given.

(1) A method of allocating the surplus allocation resource that maximizes the system efficiency includes a method of allocating all of the surplus allocation resource to the power reception apparatus that has the highest transmission efficiency.

(2) Also, a method of improving the system efficiency while securing fairness with respect to each power reception apparatus includes a method of allocating the surplus allocation resource in proportion to the transmission efficiency of each power reception apparatus.

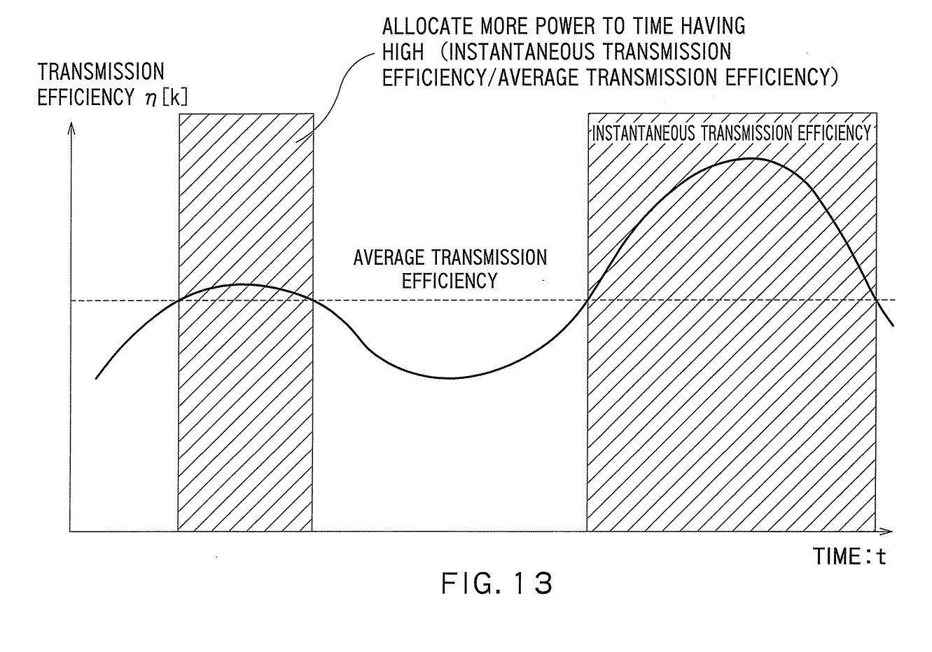

(3) Also, proportional fairness (PF) scheduling, which is widely known as a method of scheduling a wireless resource in wireless communication, may be used. The PF scheduling in the wireless communication is a system of allocating many transmission chances to a user who has a high average SNR when a SNR, which is a signal to noise ratio, is used as an evaluation function in a channel that is subject to time fluctuation, for example. Each user can obtain a chance of transmitting data at a moment when the SNR is high by employing the ratio of an instantaneous SNR to the average SNR as the evaluation criteria. Accordingly, it is possible to realize a high transmission rate while allocating the transmission chance to each user in a fair manner. It becomes possible to further improve the system efficiency while maintaining the fairness to each power reception apparatus by applying this method as the scheduling algorithm of the surplus allocation resource in the power transmission of the present proposal. Alternatively, as shown in FIG. 13, a ratio of instantaneous transmission efficiency to the average transmission efficiency may be used as the evaluation criteria. Alternatively, a ratio of instantaneous requested power to the average requested power may be used. The evaluation criteria may just be selected according to a system.

Further, when the average transmission efficiency is calculated, the power scheduling can be adaptively performed in accordance with fluctuation velocity of the transmission efficiency by introducing past transmission efficiency information. To what extent the past transmission efficiency information is used can be determined using a forgetting factor (smoothing factor).

Note that average transmission efficiency ηₐᵥₑ is calculated with the following formula where the instantaneous transmission efficiency at each sample timing tᵢ (0<i<N) is ηᵢ.

$${η}_{ave} = \frac{{\sum }_{k = 0}^{N} {η}_{k}}{N}$$

At this time, the magnitude of N depends on the capacity of a memory in which a value is stored. Therefore, this calculation method is not favorable in a case where the average is calculated for a long time. Therefore, it is possible to apply a moving average. There are various methods of calculating the moving average and any method is applicable. For example, average transmission efficiency (EMA) is calculated with the following formula using an exponential moving average (EMA).

ηₐᵥₑ=αηᵢ+(1−α)η′ₐᵥₑ

(α: Smoothing Factor (0≦α≦1), η′ₐᵥₑ: Average Transmission Efficiency Before Renewal)

In this case, because necessary data to be stored is only the average transmission efficiency before renewal and the smoothing factor. Therefore, the memory capacity can be saved. A method other than the above-described moving average method may be employed.

(4) Also, when a user who uses the power reception apparatus gives priority to each of the power reception apparatuses, it is possible to allocate the surplus allocation resource according to the priority. In such case, a method of improving the system efficiency includes a method of employing weighted PF scheduling in which weighing is applied to the PF scheduling according to the priority defined by the user. It is possible to improve the system efficiency while considering the priority defined by the user as well as maintaining the fairness between the power reception apparatuses by using this algorithm.

According to the above-described method, it is possible to improve the system efficiency by allocating the indispensable allocation resource and the surplus allocation resource. Note that the surplus allocation resource may implement an allocation method other than the above-described method. For example, a remaining amount of a battery may be employed as the priority for the power reception apparatus that include a battery.

### (Step 6: Power Control Based on an Allocation Result)

A supply of resource to each power reception apparatus is controlled and preparation for the power transmission is performed based on a scheduling result of the allocation resource determined in step 5. As soon as the preparation for power transmission is ready, a power transmission parameter is adjusted according to the scheduling result, and the power transmission to each power reception apparatus is initiated.

### (A Second Configuration Example of the Wireless Power Transmission Apparatus of the Present Embodiment)

FIG. 14 shows a second configuration example of the wireless power transmission apparatus of the present embodiment. According to FIG. 14, the wireless power transmission apparatus includes a power transmission coil 51, a power transmission driving unit 52, a power allocation processing unit 53, a power transmission control unit 54, a wireless communication unit 56, and a communication antenna 57.

The power transmission coil 51 is used as an antenna for power transmission. The power transmission driving unit 52 outputs a power signal having a predetermined frequency, voltage, and electricity to a power transmission coil. The power allocation processing unit 53 calculates allocation of a resource at the time of performing power allocation to a plurality of power reception apparatuses. The power transmission control unit 54 controls the power transmission in accordance with the allocation resource with respect to each power reception apparatus determined by the power allocation processing unit 53. The wireless communication unit 56 exchanges transmission information in relation to the power transmission efficiency with the power reception apparatus. The communication antenna 57 is an antenna for communication by the wireless communication unit 56.

Here, the allocation resource corresponds to an allocation period in a case of performing time division multiplexing, to a frequency and transmission power to be allocated to the frequency in a case of performing frequency division multiplexing, and to a space and transmission power to be allocated to the space in a case of performing space division multiplexing. Also, as a method of transmitting the power with same frequency by another method other than the time division multiplexing or space division multiplexing, there is a method of controlling the load impedance of the power reception apparatus in accordance with necessary power. In the present embodiment, a method of calculating the power allocation applicable to any of these multiplexing methods is proposed.

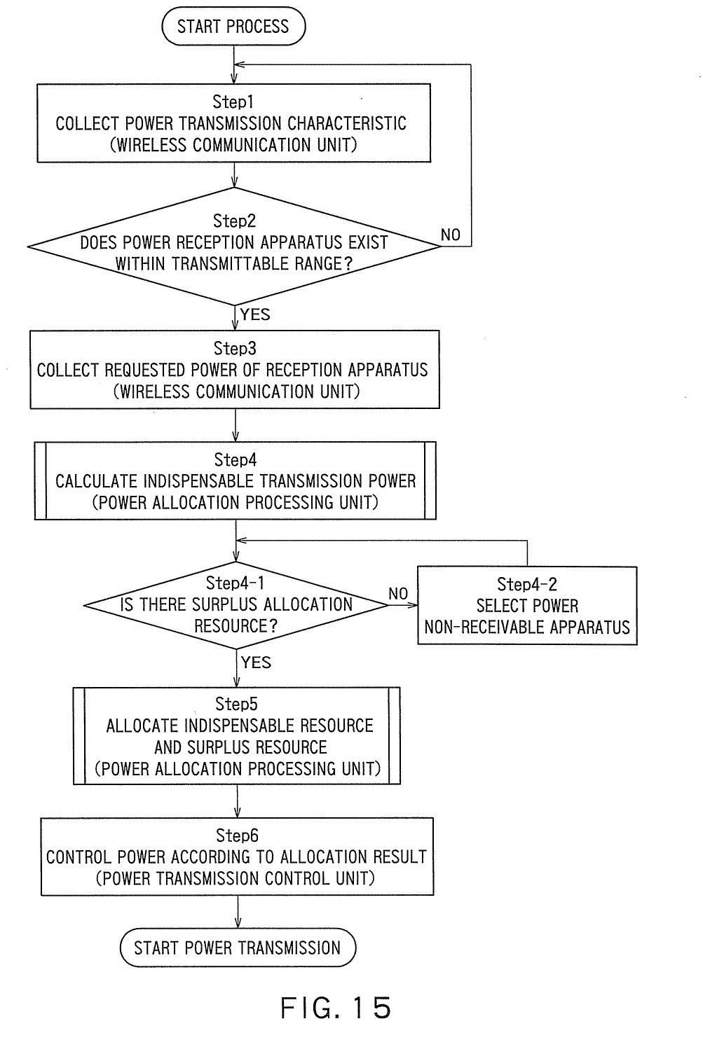

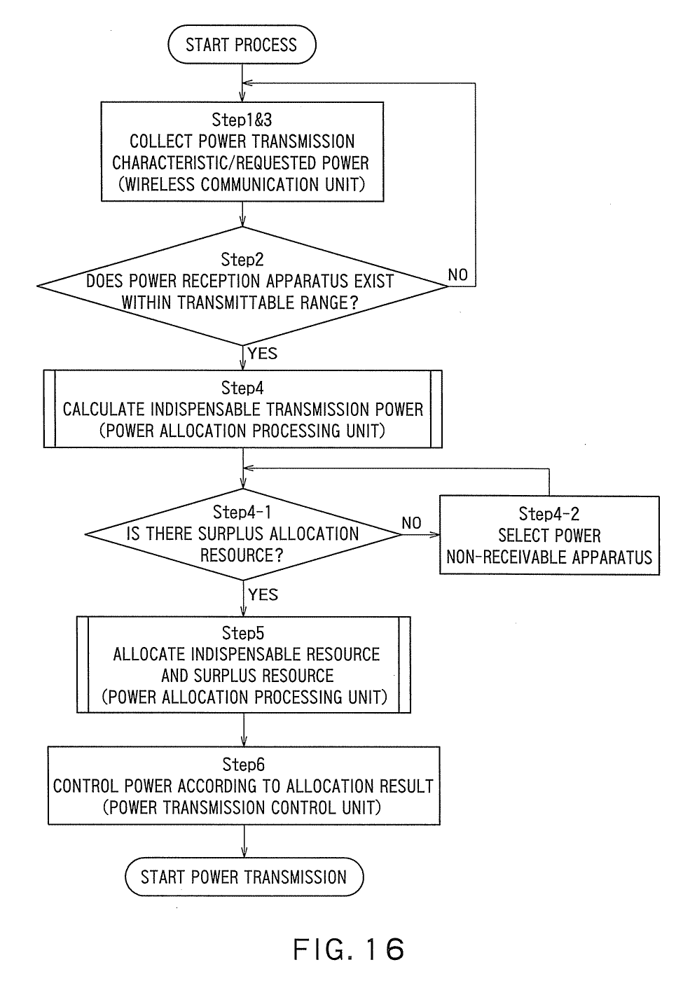

A second operation example of the wireless power transmission apparatus of the present embodiment will be described with reference to FIGS. 15 and 16. A flowchart of the second operation example is shown in FIG. 15. Because each step that is almost the same as each step of the first operation example is applicable to each step of the second operation example, different points will be described in detail.

### (Step 1: Collection of a Power Transmission Characteristic)

In the second operation example, first, as step 1, the power transmission efficiency of each power reception apparatus is collected using a wireless communication unit 56. In the first operation example, the theoretical transmission efficiency is estimated by estimating the coupling coefficient k using the reflection frequency characteristic. In this case, it is possible to estimate the transmission efficiency between power transmission coils. However, because a loss in an internal device such as an inverter of the power reception apparatus or a loss due to impedance miss matching cannot be considered, the estimated transmission efficiency is different from the transmission efficiency until the power is actually supplied to a load.

Therefore, in the second operation example, the transmission efficiency up to a load supplied with the power is calculated by measuring power supplied to the load in the power reception apparatus and feeding back a value thereof (power transmission characteristic information) from the wireless communication unit of the power reception apparatus, for example. Accordingly, error of calculation of the indispensable transmission power calculated in step 4 can be improved. As the information in relation to the power transmission characteristic to be fed back in step 1, any parameter may be fed back as long as the transmission efficiency can be calculated with the parameter.

### (Step 2: Determination of Power Transmission/Non-Transmission of a Power Reception Apparatus)

Determination of power transmission/non-transmission regarding whether the power reception apparatus in step 2 exists in a transmittable range can be realized by a method similar to the method of step 2 of the first operation example.

### (Step 3: Collection of Requested Power of the Power Reception Apparatus)

Step 3 is a step of feeding back requested power of the power reception apparatus from the wireless communication unit of the power reception apparatus to the power transmission apparatus. In the first operation example, it is assumed that the requested power information is obtained only from the power reception apparatus the requested power information of which is stored in a memory in advance. However, in the second operation example, the present proposal system is applicable to any power reception apparatus by feeding back the information from the power reception apparatus.

### (Steps 4 to 6: Overall Allocation Control)

Procedures similar to the procedures of the first operation example are applicable to steps 4 to 6. In steps 4 to 6, because the second configuration example has the wireless communication unit, it is possible to introduce a scheduling mechanism that is further in accordance with the transmission efficiency or time fluctuation of the requested power. Also, in the first operation example of the first configuration example, it is often necessary to stop the power transmission or to lower the transmission efficiency in order to estimate the transmission efficiency. However, the transmission efficiency information can be obtained without stopping the power transmission because a wireless communication device is included.

FIG. 16 shows a modification of the flowchart of the second operation example. In FIG. 16, steps 1 and 3 in FIG. 15 are integrated. Although, in the operation flow of FIG. 15, it is necessary to use the wireless communication unit in twice, in the modification shown in FIG. 16, it becomes possible to simplify the procedures by collecting the power transmission characteristic information and the requested power information at once. In and after step 4, the flowchart of the second operation example of FIG. 15 is equal to the flowchart of FIG. 16.

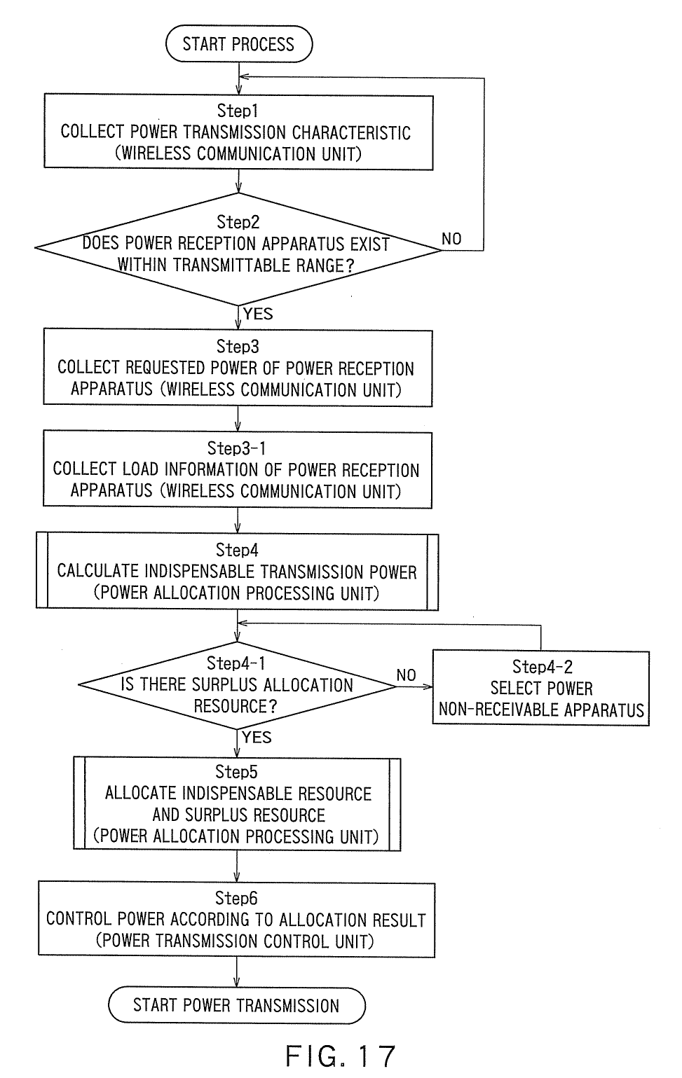

A third operation example of the wireless power transmission apparatus of the present embodiment will be described with reference to FIG. 17. FIG. 17 shows a flowchart of the third operation example. In the third operation example, a collection process of power reception apparatus load information is further added to the steps of the second operation example as step 3-1. Accordingly, selection of a power non-receivable terminal in step 4 and a method of calculating allocation of the surplus allocation resource in step 5 are different from the second operation example. Hereafter, the detail will be described.

### (Steps 1 to 3: Collection of a Power Transmission Characteristic, Determination of Power Transmission/Non-Transmission of a Power Reception Apparatus, and Collection of Information on Requested Power of a Power Reception Apparatus)

The steps 1 to 3 in the third operation example equal to that in the second operation example.

### (Step 3-1: Collection of Power Reception Apparatus Load Information)

In the third operation example, as step 3-1, a procedure of collecting load information of the power reception apparatus by the wireless communication unit 56 is added. The load information of the power reception apparatus includes the following examples.
A load type
A load value
Load driving information
In a case the load is a battery, a remaining amount of the battery
In a case the load is a battery, a charging method and a charging rate (whether normal charging or quick charging)

The load type indicates whether the power reception apparatus is a device that includes a battery and performs charging to the battery, the power reception apparatus is a device that does not include a battery and is operated while supplying the power to a load such as a CPU, or the power reception apparatus is a device that performs charging to the battery as well as supplying the power to the load.

The load value indicates a value of the load impedance to which the power is supplied.

The load driving information indicates whether a load of the power reception apparatus is being driven.

Also, in a case the load is a battery, the remaining amount of the battery, the quick charging, and the like can be realized, and therefore, a method of charging the battery (constant voltage charging, constant electricity charging) and charging rate information are also included.

The above load information is used especially for the selection of the power non-receivable terminal and the method of allocating the surplus allocation resource in steps 4 and 5.

### (Step 4: Calculation of Indispensable Transmission Power/Calculation of a Surplus Allocation Resource)

In step 4, the indispensable transmission power is calculated with the above-described formula (1) and the like although it varies according to the multiplexing method. Requested power P_{req} [k] at this time varies according to the load type.

For example, in a case of the power reception apparatus that supplies power to the load while operating (hereafter, power-supplied terminal), consumption power of the load corresponds to P_{req} [k]. In a case of the power reception apparatus that charges the battery (hereafter, power-charged terminal), power requested by the battery corresponds to P_{req} [k]. In a case of the power reception apparatus that charges the battery while supplying the power to the load as well (hereafter, power-charged/supplied terminal), the sum of the consumption power of the load and the requested power of the battery corresponds to P_{req} [k].

Then, in step 4, the surplus allocation resource is calculated with the formula (4) in the case of the time division multiplexing, with the formula (7) in the case of the frequency division multiplexing, and with the formula (10) in the case of the space division multiplexing. When the surplus allocation resource becomes negative, it is necessary to perform selection of a power non-receivable terminal.

At this time, preference is given in the order of the power-supplied terminal, the power-charged/supplied terminal, and the power-charged terminal. This is because, in a case of the power-supplied terminal, a power source becomes OFF if the power supply is interrupted because no battery is included. On the other hand, because the power-charged/supplied terminal and the power-charged terminal may include a battery, the power can be covered by the power supply from the battery even if the wireless power supply is temporarily interrupted. Therefore, the priority is low and it is more likely to be selected as the power non-receivable terminal. Further, when there are many power-charged/supplied terminals and power-charged terminals, a terminal having a battery with a small remaining amount is preferentially selected as the power-receivable terminal, and a terminal having a battery with a large remaining amount is selected as the power non-receivable terminal. Accordingly, it is possible to prevent the remaining amount of a battery from running out.

However, when the load type is the same, and there is not a substantial difference in the remaining amount of the battery among the power-charged/supplied terminals and the power-charged terminals, the power non-receivable terminal can be selected based on the transmission efficiency like the first operation example and the second operation example.

### (Step 5: Scheduling of an Allocation Resource)

Next, the fairness can be further obtained by using the load information to change the method of allocating the surplus allocation resource in step 5. Basically, the system efficiency can be improved by scheduling the allocation of the surplus allocation resource based on the transmission efficiency, and the improvement of the system efficiency and the fairness between the power reception devices can be secured by introducing a scheduling mechanism in consideration of the PF scheduling and the like. However, for example, when the transmission efficiency of the power reception apparatus having a battery with no remaining amount is always low, the allocation chance cannot be obtained and there is possibility of running out the remaining amount of the battery again. Therefore, it is possible to preferentially perform the allocation to the power reception apparatus having a battery with a less remaining amount by means of performing the weighted PF scheduling and the like by giving the priority to the remaining amount of a battery.

On the contrary, the power reception apparatus that has a battery with a nearly full remaining amount may be preferentially allocated. The nearly fully charged power reception apparatus is preferentially allocated and this power reception apparatus is fully charged, so that the power reception apparatus can be excluded from the allocation candidates, and the allocation resource to other power reception apparatuses can be increased, accordingly. It can be dynamically changed in accordance with the remaining amount of the battery of each power reception apparatus.

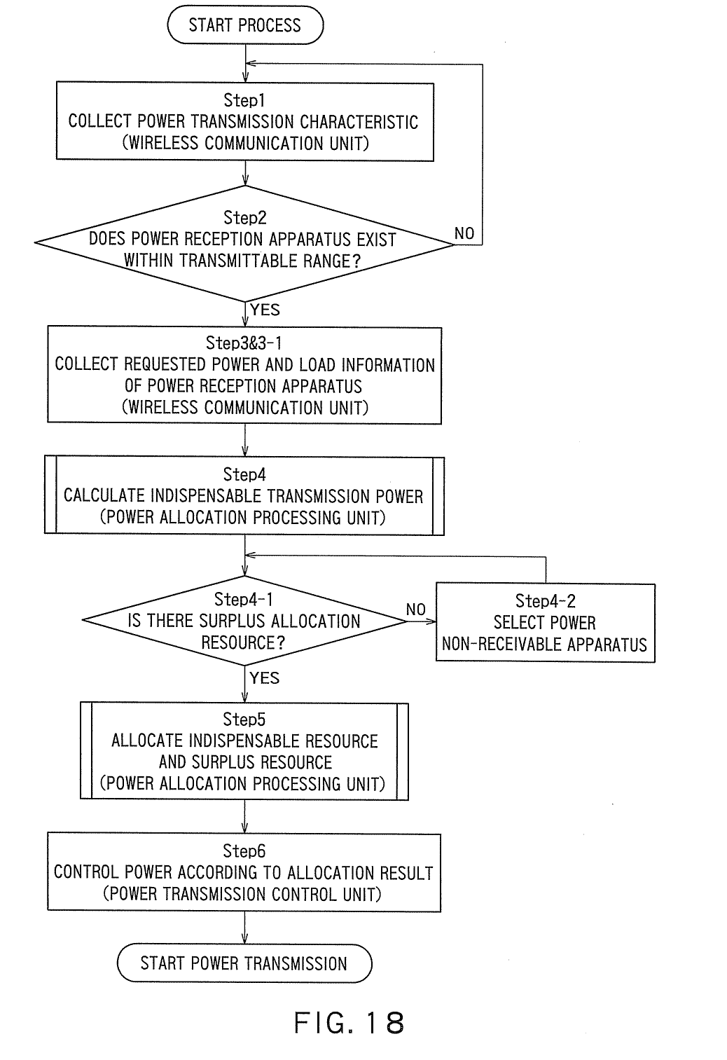

FIG. 18 shows a modification 1 of the flowchart in the third operation example. In FIG. 18, steps 3 and 3-1 of FIG. 17 are integrated. Although, in FIG. 17, it is necessary to use the wireless communication unit in twice, it becomes possible, in the modification shown in FIG. 18, to simplify the procedures by collecting the requested power information and the load information at once. In and after step 4, the flowchart of FIG. 18 is equal to the flowchart of the third operation example of FIG. 17.

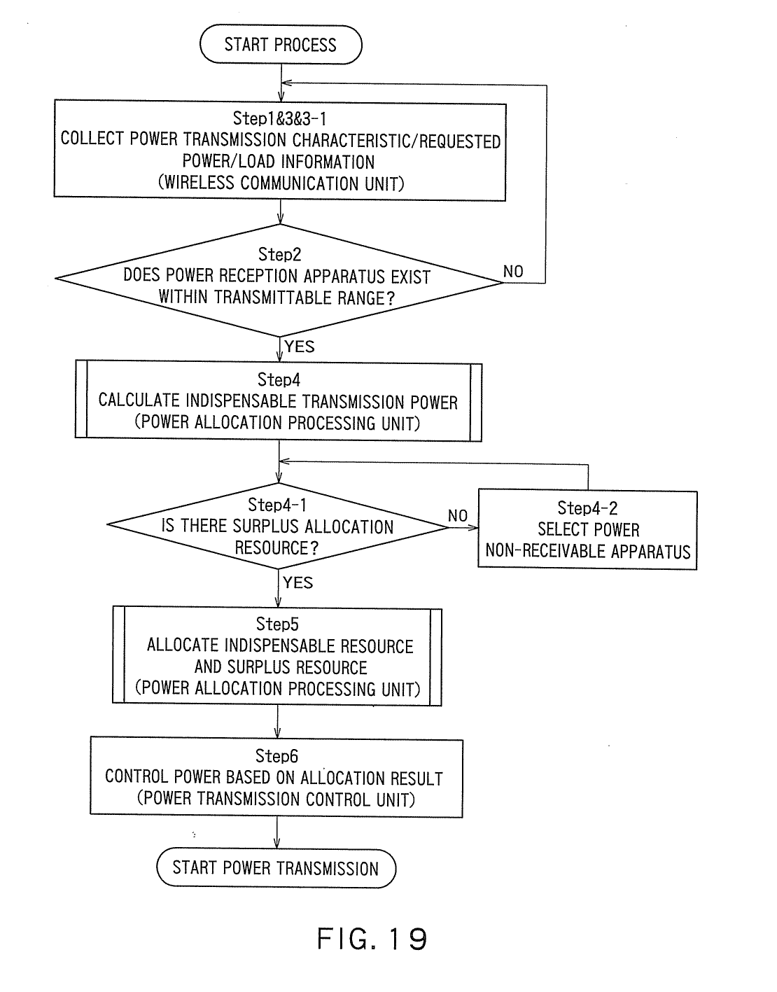

FIG. 19 shows a modification 2 of the flowchart in the third operation example. In FIG. 19, steps 1, 3, and 3-1 of FIG. 17 are integrated. Although, in FIG. 17, it is necessary to use the wireless communication unit three times, it is possible, in the modification shown in FIG. 19, to simplify the procedures by collecting the power transmission characteristic information, the requested power information, and the load information at once. In and after step 4, the flowchart of FIG. 19 is equal to the flowchart of the third operation example of FIG. 17.

FIG. 20 shows an example of the wireless power transmission system according to the present embodiment.

The power reception apparatus applied to the present embodiment is a power reception apparatus that has one or more of power reception units and is wirelessly supplied the power. Various types of configurations are applicable other than the configuration of FIG. 20. The power reception apparatus in the left of FIG. 20 includes a power reception unit 101, a rectifier 102, a load unit 103, a power control unit 104, and a wireless communication unit 105. In the right of FIG. 20, a configuration of the power reception apparatus including a plurality of power reception units 101A, 101B, and 101C is shown.

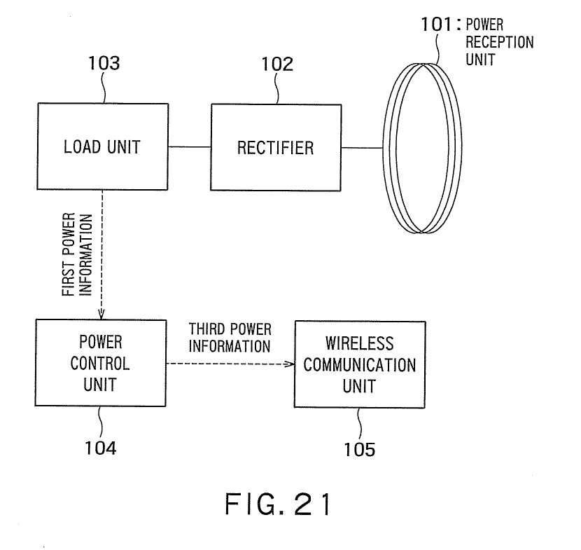

FIG. 21 shows a first configuration example of the wireless transmission power reception apparatus of the present embodiment. The present embodiment is applied to the wireless transmission power reception apparatus including a power reception unit 101 that wirelessly receives the power, a rectifier 102 that converts a high-frequency power signal obtained from the power reception unit 101 into a DC signal, a load unit (load device) 103 that is connected to the rectifier 102, a power control unit 104 that monitors the power consumed in the load unit 103, and a wireless communication unit 105 that transmits feedback information (third power information or requested power information) calculated in the power control unit 104 to the power transmission apparatus. Here, although the load unit (load device) 103 is provided in the power reception apparatus, it may be provided outside the power reception apparatus.

First, the power control unit 104 of the present embodiment monitors first power information representing the consumption power in the load unit 103. Next, second power information is calculated from a first priority that is input by a user or is determined according to the type of the power reception apparatus or the type of the load unit 103. Finally, third power information is calculated based on the monitored first power information and the calculated second power information, and is transmitted to the power transmission apparatus using the wireless communication unit 105.

Note that three cases are assumed for the load unit 103 in the power reception apparatus of the present embodiment.

Case 1. A load driven only by the supplied power in a device that does not include a battery (equivalent to the power-supplied terminal)

Case 2. A battery to which the power is charged (equivalent to the power-charged terminal)

Case 3. Combination of the battery and the load driven by the supplied power (equivalent to the power-charged/supplied terminal)

The present embodiment is applicable to all of the cases. The first power information of the present embodiment varies in some degree according to these load types. For example, the first power information means the consumption power in the load in case 1, the power to be charged to the battery or the request power required by the battery in case 2, and the power calculated from the sum of the consumption power in the load, and the power to be charged in the battery or the request power of the battery in case 3. Note that the present embodiment is widely applicable to devices that consume the power other than the above-described three cases. The second and third power information will be described in detail below.

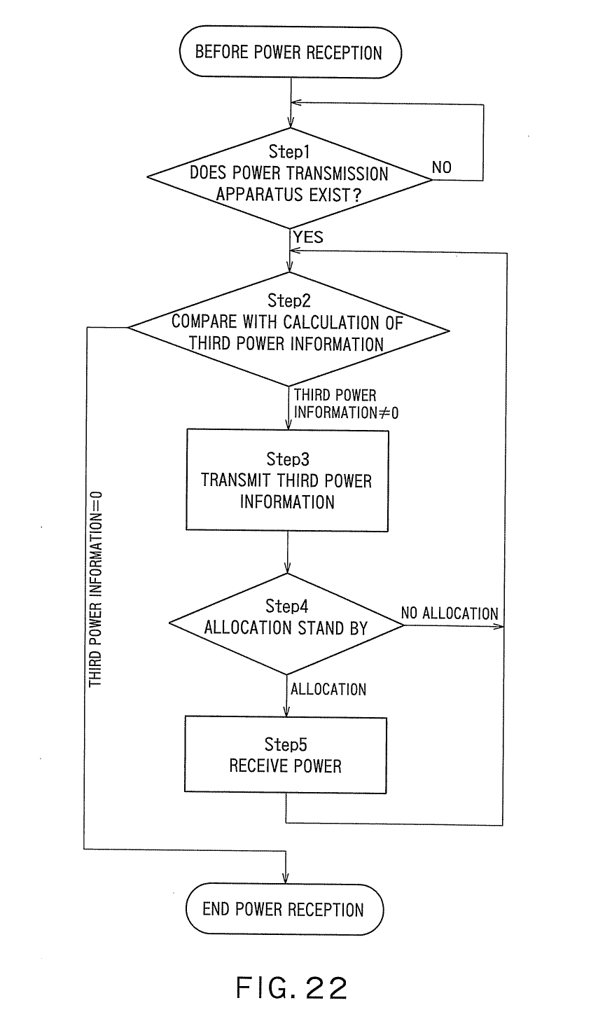

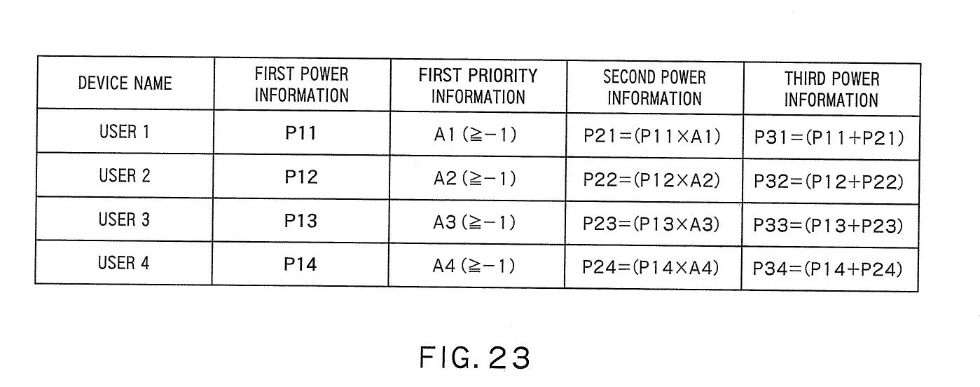

A first operation example of the wireless transmission power reception apparatus according to the present embodiment will be described with reference to FIGS. 22 and 23. FIG. 22 shows a flowchart in the first operation example.

In the first operation example of the present embodiment, the operation from the start to the end of the power reception will be described. Before starting the power reception by the wireless transmission power reception apparatus of the present embodiment, as step 1, it is necessary to recognize the proximity of the power transmission apparatus by a communication signal or a power signal from the power transmission apparatus. If the power reception apparatus does not include the battery or the remaining amount of the battery is substantially zero, the communication signal cannot be received. Therefore, existence of the power transmission apparatus is confirmed by receiving the power supply by means of test power transmission from the power transmission apparatus. If the power reception apparatus includes, the battery, and further, the remaining amount of the battery is not substantially zero, detection of the power transmission apparatus may be performed by wireless communication.

Next, as step 2, the third power information is calculated. The third power information is recognized as the requested power at the power transmission apparatus side. A method of determining the third power information will be described below with reference to FIG. 23. The fluctuation of the allocation resource can be controlled by the third power information at the side of the power reception apparatus. When the third power information becomes 0, the power reception is terminated, and when the third power information is not 0, the flow moves into the next step.

Next, in step 3, the third power information calculated in step 2 is transmitted to the power transmission apparatus.

When the third power information is transmitted, the flow transits to allocation stand by in step 4. At this time, if there is no allocation, the flow transits to a mode of calculating the third power information in step 2. If there is allocation, the flow proceeds to the power reception in step 5. The power reception in step 5 is performed in a power frame that is divided into certain periods. When the power frame ends, the flow returns to step 2. In step 2, the third power information is calculated again, and when the third power information becomes 0, the power reception is terminated. If the third power information is not 0, the flow enters step 3 again and loops.

FIG. 23 is a diagram for describing step 2 in detail. Step 2 is a step for transmitting the third power information, and a method of calculating the third power information will be described.

The third power information is recognized in the power transmission apparatus as power information required by the power reception apparatus. That is, the wireless transmission power reception apparatus of the present embodiment enables the control of the allocation resource at the power reception apparatus side by purposely increasing/decreasing the third power information.

The third power information is calculated from the first and second power information. The first power information means the consumption power in the load or the requested power of the battery. That is, the first power information is the indispensable power information for maintaining the power supply in the load unit on a steady basis. Next, the second power information is calculated from the first priority information and the first power information. This second power information is power information that increases/decreases according to the priority, and is calculated with the formula shown in FIG. 23, for example.

Second power information (P12)=First priority information (A1)×First power information (P11)

The first priority information (A1) takes a value equal to or more than −1, that is, a value range of the second power information (P12) becomes −P11≦P12.

Further, the third power information is calculated with the following formula.

Third power information (P13)=First power information (P11)+Second power information (P12)

Because the value range of the second power information (P12) is −P11≦P12, a value range of the third power information (P13) is P13≧0. That is, the second power information (P12) is power information increasing/decreasing the first power information that means the necessary power in accordance with the first priority information. When the power supply with equal to or less than the power required by the load is performed, the second power information is set negative, and when the power supply with equal to or more than the power required by the load is performed, the second power information is set positive, whereby it becomes possible to perform the control in accordance with the power required by the load indicated in the first power information.

Further, a fixed value or a variable value is applicable to the first priority information. For example, the value is renewed so as to increase the first priority information with respect to the power reception apparatus that has not been allocated in step 4 of FIG. 22 or to decrease the first priority information with respect to the allocated power reception apparatus, whereby the resource can be allocated to the power reception apparatus having a less allocation chance and the fairness can be secured in the resource allocation.

The first priority information may be set by an input from a user in a configuration that includes an input unit from the user, or may use a value arbitrarily set according to the type of the device of the power reception apparatus or the load type.

Note that the methods of calculating the first priority information, the second power information, and the third power information are not limited to the above described methods, and other methods can be used without departing from the scope of the invention.

The above-described embodiments of the present invention are widely applicable to the wireless power transmission technology, and are also applicable to the wired power supply technology or a smart grid.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A power transmission apparatus which transmits power generated by a power source to one or more power reception apparatuses, comprising:
a power allocation processing unit configured to allocate first resources which are parts of resources for transmitting the power to the power reception apparatuses, based on requested power of the power reception apparatuses, and to allocate second resources which are resources with the exception of first resources to a power reception apparatus selected from the power reception apparatuses based on power transmission characteristics of the power reception apparatuses, and
a power transmission unit to transmit the power to the power reception apparatuses using first resources and second resources.

2. The power transmission apparatus according to claim 1, further comprising:
a power transmission characteristic estimator,
wherein the power transmission unit includes at least one transmission coil, and transmits the power by the transmission coil via magnetic coupling with power reception coils of the power reception apparatuses, and
the power transmission characteristic estimator estimates the power transmission characteristic of the power reception apparatuses based on a coupling coefficient between the transmission coil and each power reception coil.

3. The power transmission apparatus according to claim 1, further comprising:
a wireless communication unit to perform wireless communication with the power reception apparatuses, and to obtain information indicating power received by the power reception apparatuses,
wherein the power allocation processing unit calculates the power transmission characteristic of the power reception apparatuses using the information.

4. The power transmission apparatus according to claim 1,
wherein the power transmission unit performs multiplex transmission by time division,
the power allocation processing unit allocates a power transmission time which is a part of a power frame length as the resource to each power reception apparatus, and
second resources are a remaining time that remains after the power transmission time is allocated to each power reception apparatus.

5. The power transmission apparatus according to claim 1,
wherein the power transmission unit performs multiplex transmission by frequency division,
the power allocation processing unit allocates a frequency selected from within a frequency band in use and transmission power being a part of total power available in transmission as the resource to each power reception apparatus, and
second resources include a remaining frequency that remains after the frequency is allocated to each power reception apparatus and remaining power that remains after the transmission power is allocated to each power reception apparatus.

6. The power transmission apparatus according to claim 1,
wherein the power transmission unit performs multiplex transmission by space-dividing a transmission space,
the power allocation processing unit allocates a partial space being a part of the transmission space and transmission power being a part of total power available in transmission as the resource to each power reception apparatus, and
second resources include a remaining space that remains after the partial space is allocated to each power reception apparatus and remaining power that remains after the transmission power is allocated to each power reception apparatus.

7. The power transmission apparatus according to claim 1,
wherein the power transmission characteristic of the power reception apparatus is determined according to the requested power and power transmission efficiency of the power reception apparatus.

8. The power transmission apparatus according to claim 1,
wherein the power allocation processing unit performs resource allocation to the power reception apparatus based on indispensable transmission power of the power reception apparatus, the indispensable transmission power being calculated by dividing the requested power of the power reception apparatus by the power transmission efficiency of the power reception apparatus.

9. The power transmission apparatus according to claim 8,
wherein, when a quantity of resources required to allocate to the power reception apparatuses is insufficient, the power allocation processing unit selects at least one power reception apparatus from among the power reception apparatuses, and does not allocate any resource to the selected power reception apparatus.

10. The power transmission apparatus according to claim 9,
wherein the power allocation processing unit selects the power reception apparatus based on the power transmission efficiency of each power reception apparatus.

11. The power transmission apparatus according to claim 9,
wherein the power allocation processing unit selects the power reception apparatus based on a type of a load in each power reception apparatus and driving information of the load.

12. The power transmission apparatus according to claim 11,
wherein the type of a load indicates whether the load is driven by which of a battery and a non-battery power source, and
the driving information of the load indicates power consumed by the load, power requested by the load, or a remaining amount of the battery.

13. The power transmission apparatus according to claim 1,
wherein the power allocation processing unit selects a power reception apparatus to which second resources are allocated based on the power transmission efficiency of each power reception apparatus.

14. The power transmission apparatus according to claim 1,
wherein the power allocation processing unit selects a power reception apparatus to which second resources are allocated based on a ratio of an instantaneous transmission efficiency to an average transmission efficiency in each power reception apparatus.

15. The power transmission apparatus according to claim 1,
wherein the power allocation processing unit selects a power reception apparatus to which second resources are allocated based on a ratio of instantaneous requested power to average requested power in each power reception apparatus.

16. The power transmission apparatus according to claim 1,
wherein the power allocation processing unit selects a power reception apparatus to which second resources are allocated based on a type of a load in each power reception apparatus and driving information of the load.

17. The power transmission apparatus according to claim 16,
wherein the type of a load indicates whether the load is driven by which of a battery or a non-battery power source, and
the driving information of the load indicates power consumed by the load, power requested by the load, or a remaining amount of the battery.

18. A power reception apparatus, comprising:
a wireless communication unit to wirelessly communicate with a power transmission apparatus;
a power reception unit to wirelessly receive power from the power transmission apparatus;
a driving unit to drive a load using the power received by the power reception unit; and
a power control unit configured to monitor power consumed on the load,
wherein the power control unit generates information indicating power to request to the power transmission apparatus, based on a value of the power consumed on the load and a priority set in advance, and
the wireless communication unit transmits the information to the power transmission apparatus.

19. The power reception apparatus according to claim 18,
wherein the power control unit generates the information by making the value of the power consumed on the load increased or decreased according to the priority.

20. The power reception apparatus according to claim 18,
wherein the load includes a battery that accumulates the power.

21. The power reception apparatus according to claim 18,
wherein the priority is determined according to a remaining amount of the battery.

22. A power transmission method which transmits power generated from a power source to one or more power reception apparatuses, comprising:
allocating first resources which are parts of resources for transmitting the power to the power reception apparatuses, based on requested power of the power reception apparatuses, and allocating second resources which are resources with the exception of first resources to a power reception apparatus selected from the power reception apparatuses based on power transmission characteristics of the power reception apparatuses, and
transmitting the power to the power reception apparatuses using first resources and second resources.
